(19) United States
(12) Patent Application Publication
(10) Pub. No.: US 2008/0178698 A1
(43) Pub. Date: Jul. 31, 2008

(54) SHAFT ANTISEIZING TYPE SPROCKET

(76) Inventor: Koji TANAKA, Osaka (JP)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/947,128

(22) Filed: Nov. 29, 2007

(30) Foreign Application Priority Data
Jan. 31, 2007 (JP) 2007-022433

(51) Int. Cl. F16H 57/04

(52) U.S. Cl. 74/467

(57) ABSTRACT

A shaft antiseizing type sprocket in which seizing liable to occur in the contact portion between the sprocket and the sprocket shaft is completely avoided for a long period of use. Effecting replacement is possible without use of a special-purpose removing tool or a fixing tool with a rotating body. The shaft antiseizing type sprocket has a boss portion which is integrally molded with a sprocket tooth portion. The boss has a shaft bore, the inner circumferential surface of which is adapted to be fixed to a sprocket shaft. A solid lubricant is embedded in the boss portion, and is disposed in a partially exposed state toward the shaft bore inner circumferential surface of the boss portion.

### FIELD OF INVENTION

The present invention relates to a sprocket, which is incorporated and fixed to a sprocket shaft in a power transmission mechanism, and more specifically it relates to a shaft antiseizing type sprocket, in which seizing with a sprocket shaft is prevented and installation replacement is possible.

### BACKGROUND OF THE INVENTION

When damage such as wear or the like is generated in a sprocket tooth portion, a sprocket, which is installed and fixed to a sprocket shaft in a power transmission mechanism or the like, is replaced. Since heavy seizing is generated at a contact portion with the sprocket shaft with the sprocket depending on a use load and use time of the sprocket to be replaced, the sprocket is impossible to remove from the sprocket shaft.

Thus, when a sprocket had damage such as wear or the like, a sprocket tooth portion is removed from the sprocket shaft, the sprocket. a sprocket is forcibly removed from the sprocket shaft through a special-purpose removing tool called a gear puller or the like (see for example Japanese Laid-Open Patent Publication No. 2002-361571 (page 1, FIG. 1)) or a sprocket of a special shape in which only a tooth portion damaged by wear or the like can be replaced is used (see for example Japanese Examined Patent Publication No. Sho. 61-28862 (page 1, FIG. 1)), and a sprocket is removably mounted to the sprocket shaft using a mounting having a rotating body, which fastens the sprocket by tapered surfaces of an inner ring and an outer ring (see for example Japanese Laid-Open Patent Publication No. Hei. 10-37971 (page 1, FIG. 1)).

### PROBLEMS TO BE SOLVED BY THE INVENTION

However, the removing special-purpose tool disclosed in Japanese Laid-Open Patent Publication No. 2002-361571 (page 1, FIG. 1) needs not only large working labor at the removal but also a sprocket damaged by wear or the like in a sprocket tooth portion is needed only in a case where the sprocket is removed from the sprocket shaft. Thus there was a troublesome problem that the removing special-purpose tool must be stored separately until the time when it is desired to use it.

In a sprocket of a special shape disclosed in Japanese Examined Patent Publication No. Sho. 61-28862 (page 1, FIG. 1) in which only a tooth portion can be replaced, there was a problem that a shape structure of the sprocket is complicated and the handling of the sprocket is troublesome, and additionally the sprocket becomes expensive.

Further, there was a problem that a fixing tool of a rotating body, which fastens the sprocket by tapered surfaces of an inner ring and an outer ring disclosed in Japanese Laid-Open Patent Publication No. Hei. 10-37971 (page 1, FIG. 1) needs a number of parts for attaching the sprocket and additionally the sprocket becomes expensive.

Therefore, since any solutions disclosed in these patent references are post-measures when seizing was generated at a contact portion between the sprocket and the sprocket shaft, various solutions to positively avoid such seizing have been labored and studied.

Namely, application of a lubricant such as oil or grease to the sprocket and the sprocket shaft has been tried. However, since the clearance gap between the sprocket and the sprocket shaft designed according to JIS-B-0401 is narrow, there was a problem that a transient application of the lubricant cannot maintain an oil film during heat generation, such as by kinetic energy and the like, and complete avoidance of seizing cannot be attained.

Thus, while paying attention to the heat generation, such as by kinetic energy and the like liable to occur in a sprocket, the present invention has solved the above-mentioned conventional problems.

Namely, the object of the present invention is to provide a shaft antiseizing type sprocket in which seizing liable to occur in the contact portion between the sprocket and the sprocket shaft is completely avoided in a simple sprocket structure for a long period of time and installation replacement is possible without use of a special-purpose removal tool or a mounting having a rotating body.

### SUMMARY OF THE INVENTION

The invention solves the above-mentioned problems by a shaft antiseizing type sprocket in which the inner circumferential surface of the shaft bore in the boss portion is integrally molded with the sprocket teeth portion and is installed on a sprocket shaft. The invention is characterized in that a solid lubricant is disposed in said boss portion in a state where it is partially exposed to the inner circumferential surface of the shaft bore in the boss portion.

The shaft antiseizing type sprocket further solves the above-mentioned problems by that in addition, said solid lubricant is solidified in polyethylene with the lubricant being dispersedly held.

According to the present invention, when a shaft bore inner circumferential surface of a boss portion integrally molded with a sprocket teeth portion is installed and fixed to a sprocket shaft, a special fixing tool on a rotating body is not needed and the following effects can be obtained by the claimed sprocket structure.

Namely, a solid lubricant embedded in the boss portion is disposed in a partially exposed state toward the inner circumferential surface of the shaft bore in the boss portion, a solid lubricant, which is gradually softened by heat generated such as by kinetic energy or the like occurring in the sprocket. The lubricant forms an oil film in the gap between the inner circumferential surface of the sprocket shaft bore and the sprocket shaft by swelling and capillary attraction. Thus, seizing liable to occur in the contact portion between the sprocket and the sprocket shaft is avoided by this simple sprocket structure so that an easy installation and replacement can be attained.

According to the shaft antiseizing type sprocket of the invention, since the solid lubricant is solidified in polyethylene with lubricant dispersedly held, in addition to the above-mentioned effects obtained by the invention, polyethylene and the solid lubricant is gradually softened by heat generation such as kinetic energy, which occurs in the sprocket during power transmission, and the lubricating oil dispersed and held in polyethylene is gradually diffused. Therefore, lubricating oil enough to form an oil film within a gap between the inner circumferential surface of the sprocket shaft bore and the sprocket shaft can be continuously supplied for a long period of time.

If in a shaft antiseizing type sprocket in which the inner circumferential surface of the shaft bore in a boss portion integrally molded with a sprocket teeth portion is installed and fixed to a sprocket shaft, a solid lubricant confined in said boss portion is disposed in a partially exposed state toward the shaft bore inner circumferential surface of said boss portion, seizing liable to occur in the contact portion between a sprocket and the sprocket shaft is completely avoided by a simple structure for a long period of time and installation of a replacement sprocket is possible without use of special-purpose tool or mounting tool having a rotating body. Any concrete embodiment of the present invention may be used.

For example, according to the invention, sprockets which may be power transmitting components are attached to a transmitting shaft or the like and are removed. For example, the term “sprockets” includes not only sprockets in a narrow sense but also gears and chain wheels.

Further, the basic shapes of sprockets of the present invention may be formed by casting and forging or machining such as sintering, cutting and the like, or any one of these fabricating methods.

Any arrangement formed of a solid lubricant confined in the sprocket of the present invention may be used in which the solid lubricant is directed toward an inner circumferential surface of a shaft bore of a boss portion in a partially exposed state. For example, one may use a form in which a solid lubricant is radially arranged from an inner circumferential surface of a shaft bore of the boss portion toward the inside of the boss portion, or a form in which a solid lubricant is dispersedly arranged along the inner circumferential surface of the shaft bore of the boss portion.

It is noted that the solid lubricants used in the present invention are either embedded in a boss portion in a state where lubricating oil is mixed into polyethylene or are attached to the inside of a boss portion in an expanded resin or a porous body holding the lubricating oil in a dispersedly held state. The lubricating oil sinks into the expanded resin or a porous body capable of containing the lubricating oil. Any appropriate embodiment of the solid lubricant may be used.

### BRIEF DESCRIPTION OF THE DRAWINGS

Examples of shaft antiseizing type sprockets according to the present invention will be described with reference to drawings, wherein

FIG. 1 is a plan view of a shaft antiseizing type sprocket, which is a first example of the present invention;

FIG. 2 is a perspective view, cutout through an angled line A-A, of the shaft antiseizing type sprocket shown in FIG. 1;

FIG. 3 is a plan view of a shaft antiseizing type sprocket, which is a second example of the present invention;

FIG. 4 is a perspective view cutout through an angled line A-A, of the shaft antiseizing type sprocket shown in FIG. 3;

FIG. 5 is a plan view of a shaft antiseizing type sprocket, which is a third example of the present invention;

FIG. 6 is a perspective view, cutout through an angled line A-A, of the shaft antiseizing type sprocket shown in FIG. 5;

FIG. 7 is a plan view of a shaft antiseizing type sprocket, which is a fourth example of the present invention;

FIG. 8 is a perspective view, cutout through an angled line A-A, of the shaft antiseizing type sprocket shown in FIG. 7; and

FIG. 9 is a perspective view of a shaft illustrating a means for fixing the sprockets to the shaft.

### DESCRIPTION OF PREFERRED EMBODIMENTS

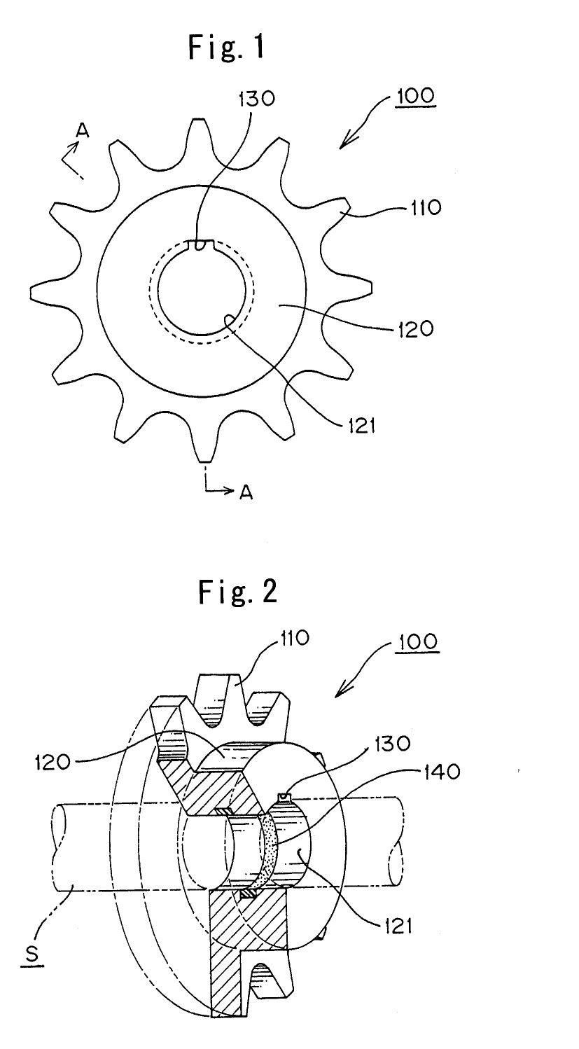

With reference to FIGS. 1 and 2, a shaft antiseizing type sprocket 100, which is a first example of the present invention, includes sprocket tooth portions 110 and a boss portion 120 integrally molded to the sprocket tooth portions 110, and is formed so that a keyway 130 is formed in an inner circumferential surface 121 of a shaft bore of the boss portion 120. The sprocket 100 is incorporated and fixed to a sprocket shaft S (FIG. 9) in a power transmitting mechanism or the like through a key K which engages a keyway 130. The sprocket 100 can be replaced when wear loss is generated in a sprocket tooth portion 110, or when the number of sprocket teeth is changed or the like.

A solid lubricant 140 in the form of an annular ring is embodied in the boss portion 120 for avoiding seizing which is liable to occur in the contact portion between the inner circumferential surface 121 of the shaft bore of the sprocket 100 and the sprocket shaft S. The solid lubricant 140 is disposed toward the central region of the inner circumferential surface 121 of the shaft bore in the boss portion 120 in a partially exposed state.

Further, the solid lubricant 140 is in the form of an annular ring embedded in the boss portion 120 in a state where lubricating oil is dispersedly held in polyethylene

It is noted that in a case of the first example the lubricating oil is embedded in the boss portion 120 in a state where lubricating oil is mixed into polyethylene in a dispersedly held state.

According to the first example, since the solid lubricant 140 embedded in a boss portion 120 is disposed in a partially exposed state toward the inner circumferential surface 121 of the shaft bore of the boss portion 120, the solid lubricant 140 is gradually softened by heat generated by kinetic energy or the like during power transmission and is swelled and by a capillary attraction, forms an oil film in the clearance gap between the shaft bore inner circumferential surface 121 and the sprocket shaft S. Accordingly, seizing which normally occurs in the contact portion between the sprocket and the sprocket shaft S is avoided and an easy bodily replacement can be achieved in the simple sprocket structure of the present invention.

Since the solid lubricant 140 used in the first example is solidified in polyethylene with lubricant dispersedly held, polyethylene and the solid lubricant 140 is gradually softened by heat generation, in the sprocket 100 which occurs during power transmission such as by kinetic energy, and lubricating oil dispersed and held in the polyethylene is gradually diffused. Therefore, lubricating oil enough to form an oil film in the clearance gap between the inner circumferential surface 121 of the sprocket shaft bore and the sprocket shaft S can be continuously supplied for a long period of time. When the temperature of the portion of the boss 120 in contact with the sprocket shaft S is excessively increased, the molecular movement of polyethylene is activated so that a mutual separating action is accelerated. Thus, an amount of dispersed lubricating oil is increased so that seizing is avoided. Therefore, the advantageous effects of the first example are very large.

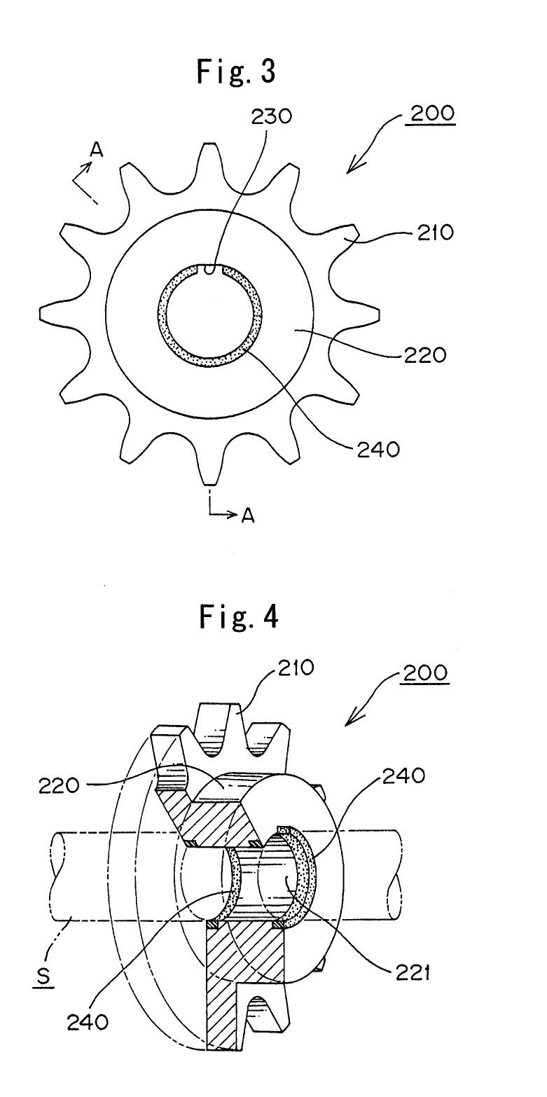

A second example of the present invention is shown in FIG. 3 and FIG. 4.

A shaft antiseizing type sprocket 200 includes sprocket tooth portions 210 and a boss portion 220 integrally molded to this sprocket tooth portions 210 as in the first example, and is formed so that a keyway 230 is formed the inner circumferential surface 221 of the shaft bore of the boss portion 220. The sprocket 200 is fixed to a sprocket shaft S in a power transmitting mechanism or the like through a key K and the keyway 230. The sprocket 200 may be replaced when wear loss is generated in a sprocket tooth portion 210, or when the number of sprocket teeth is changed or the like.

A solid lubricant 240 is disposed in the boss portion 220 for avoiding seizing liable to occur in a contact portion between the inner circumferential surface 221 of the shaft bore of the boss portion 220 of the sprocket 200 and the sprocket shaft S. The lubricant 240 is disposed toward opening portions on both ends of the inner circumferential surface 221 of the shaft bore in the boss portion 220 in a partially exposed state.

Further, the solid lubricant 240 is embedded in the boss portion 220 in a state where lubricating oil is dispersedly held in polyethylene

In the second example, the lubricating oil comprises a pair of annular rings embedded in the boss portion 220 in a state where lubricating oil is mixed into polyethylene in a dispersedly held state.

According to the shaft antiseizing type sprocket 200 of the second example, a solid lubricant 240 embedded in the boss portion 220 is disposed in a partially exposed state toward the inner circumferential surface 221 of the shaft bore of the boss portion 220, the solid lubricant 240 gradually softened by heat generated by kinetic energy or the like during power transmission, and a capillary attraction forms an oil film at the clearance gap between the shaft bore inner circumferential surface 221 and the sprocket shaft S. Accordingly, seizing liable to occur at a contact portion between the sprocket and the sprocket shaft S is avoided and an easy replacement can be attained by the simple sprocket structure of the present invention.

The solid lubricant 240 comprises annular rings concentrically disposed with the shaft bore inner circumferential surface 221 of the boss portion 220. The solid lubricant 240 is disposed toward open portions on both ends of the inner circumferential surface 221 of the shaft bore of the boss portion 220 in a partially exposed state. Even if the solid lubricant 240 is used with a vertically disposed sprocket shaft S, an oil film is formed over the entire region of contact of the shaft with the inner circumferential surface 221 of the shaft bore of the boss portion 220. Therefore, partial seizing of the contact portion with the inner circumferential surface 221 of the shaft bore of the boss portion 220 can be avoided.

Since the solid lubricant 240 used in the second example is solidified in polyethylene with lubricant dispersedly held, the polyethylene of the solid lubricant 240 is gradually softened by heat generated by kinetic energy, which occurs in the sprocket 200 during power transmission. Lubricating oil dispersed and held in polyethylene is therefore gradually diffused, and lubricating oil enough to form an oil film in the clearance gap between the inner circumferential surface 221 of the sprocket shaft bore and the sprocket shaft S can be continuously supplied for a long period of time. When the temperature of the contact portion with the sprocket shaft S is excessively increased, the molecular movement of polyethylene is activated so that a mutual separating action is accelerated. Thus an amount of dispersed lubricating oil is increased so that seizing is avoided. Therefore, the advantageous effects of the first example are very large.

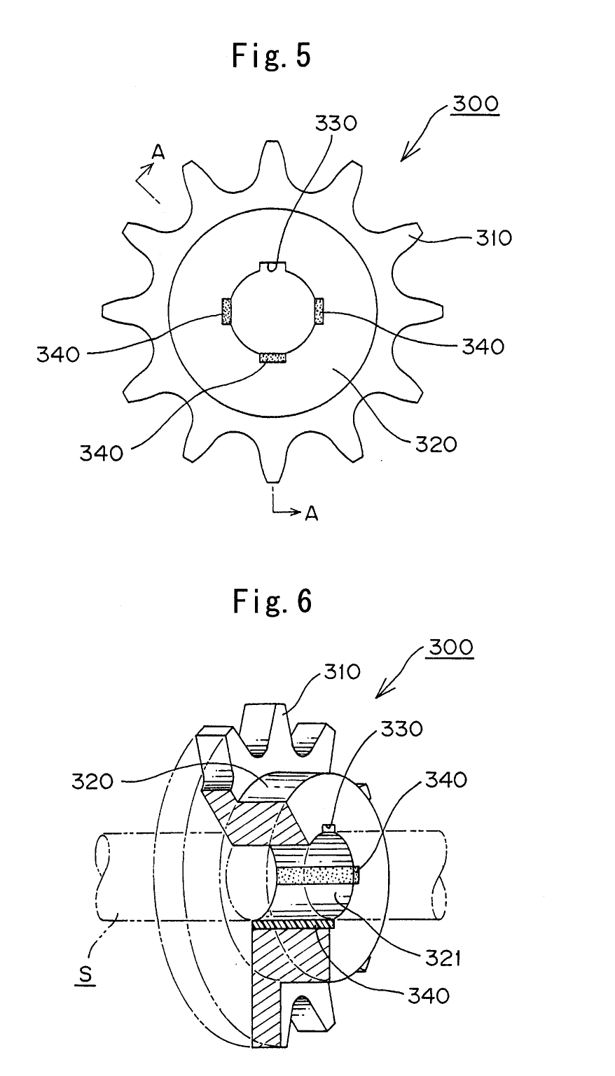

A third example of the present invention is shown in FIG. 5 and FIG. 6.

A shaft antiseizing type sprocket 300 includes a sprocket tooth portions 310 and a boss portion 320 integrally molded to this sprocket tooth portions 310 as in the first example, and is formed so that a keyway 330 formed in a shaft bore inner circumferential surface 321 of the boss portion 320 is incorporated and fixed to a sprocket shaft S in a power transmitting mechanism or the like through a key K. The sprocket 300 can be replaced when wear loss is generated in a sprocket tooth portion 310, or when the number of sprocket teeth is changed or the like.

A solid lubricant 340 is dispersedly disposed for avoiding seizing liable to occur in the contact portion between the sprocket 300 and the sprocket shaft S. The solid lubricant 340 is embedded in axial grooves at three positions other than the keyway 330 along the shaft bore inner circumferential surface 321 of the boss portion 320 in a partially exposed state.

Further, the solid lubricant 340 is embedded in the boss portion 320 in a state where lubricating oil is dispersedly held in polyethylene.

It is noted that in a case of the third example the lubricating oil is a plurality of axially-extending bars embedded in a boss portion 320 in a state where lubricating oil is mixed into polyethylene in a dispersedly held state of lubricating oil.

According to the shaft antiseizing type sprocket 300 of the third example, since the solid lubricant 340 in the boss portion 320 is disposed in a partially exposed state toward the inner circumferential surface 221 of the shaft bore of the boss portion 320, the solid lubricant 340 is gradually softened by heat generated by kinetic energy or the like generated during power transmission and is swelled by a capillary phenomenon to form an oil film at a gap between the inner circumferential surface 321 and the sprocket shaft S. Accordingly, seizing liable to occur in the contact portion between the sprocket 300 and the sprocket shaft S is avoided and an easy replacement can be achieved in a simple sprocket structure.

Since the solid lubricant 340 is dispersedly disposed at three positions other than the keyway 330 along the inner circumferential surface 321 in a partially exposed state, an oil film is formed over the entire region of a contact portion with the inner circumferential surface 321 of the shaft bore of the boss portion 320 other than the keyway 330. Thus, the key K is not dislodged inadvertently and seizing of the contact portion with the shaft bore inner circumferential surface 321 of the boss portion 320 can be completely avoided.

The solid lubricant 340 used in the third example is solidified in polyethylene with lubricant dispersedly held, and the polyethylene of the solid lubricant 340 is gradually softened by heat generated by kinetic energy, which occurs in the sprocket 300 during power transmission and, as a result, lubricating oil dispersed and held in polyethylene is gradually diffused. Therefore, lubricating oil enough to form an oil film in the clearance gap between the inner circumferential surface 321 of the sprocket shaft bore and the sprocket shaft S can be continuously supplied for a long period of time. When the temperature in the contact portion with the sprocket shaft S is excessively increased, the molecular movement of polyethylene is activated so that a mutual separating action of the lubricant 340 is accelerated. Thus, an amount of dispersed lubricating oil is increased so that seizing is avoided. Therefore, the advantageous effects of the example are very large.

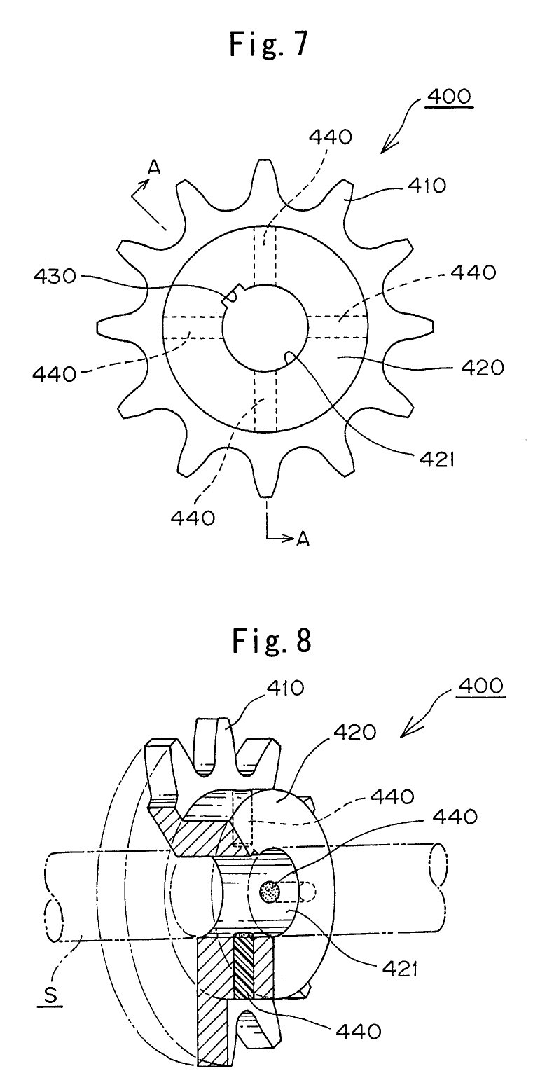

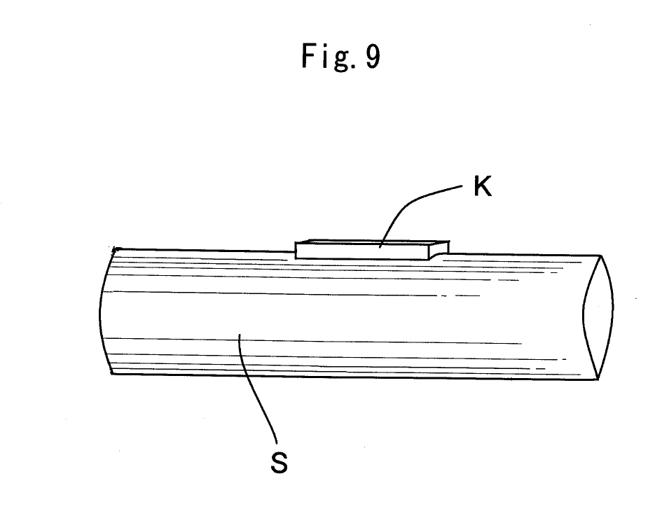

A fourth example of the present invention is shown in FIG. 7 and FIG. 8.

In these figures, a shaft antiseizing type sprocket 400 includes a sprocket tooth portions 410 and a boss portion 420 integrally molded to the sprocket tooth portions 410 as in the first example, and is formed so that a keyway 430 is formed in the shaft bore inner circumferential surface 421 of the shaft bore of the boss portion 420. The sprocket 400 is fixed to a sprocket shaft S in a power transmitting mechanism or the like through a key K. The sprocket can be bodily replaced when wear loss is generated in a sprocket tooth portion 410, or when the number of sprocket teeth is changed or the like.

Radially-extending plugs of a solid lubricant 440 are dispersedly disposed in the boss portion 420 for avoiding seizing liable to occur in the contact portion between a sprocket 400 and the sprocket shaft S. The plugs are disposed at four positions other than the keyway 430 and extend radially inward toward the inner circumferential surface 421 of the shaft bore of the boss portion 420 in a partially exposed state. In this embodiment, the plugs of lubricant 440 are embedded in a plurality of radial bores extending from the circumferential surface 421 outwardly to an exterior surface of the boss portion 420.

Further, the solid lubricant 440 is embedded in the boss portion 420 in a state where lubricating oil is dispersedly held in polyethylene

It is noted that in a case of the fourth example, the lubricating oil is embedded in a boss portion 420 in a state where lubricating oil is mixed into polyethylene in a dispersedly held state of lubricating oil.

According to the shaft antiseizing type sprocket 400 of the fourth example, since a solid lubricant 440 possessed in a boss portion 420 is disposed in a partially exposed state toward the shaft bore inner circumferential surface 421 of the boss portion 420, the solid lubricant 440 is gradually softened by heat generated by kinetic energy or the like generated during power transmission and is affected by a capillary attraction to form an oil film in the clearance gap between the shaft bore inner circumferential surface 421 and the sprocket shaft S. Accordingly, seizing liable to occur at a contact portion between the sprocket and the sprocket shaft S is avoided and an easy bodily replacement can be achieved with the simple sprocket structure.

Each solid lubricant 440 plug is dispersedly embedded at four positions other than the keyway 430 and extends radially from the shaft bore inner circumferential surface 421 toward the boss portion 420 a in a partially exposed state, an oil film is formed over the entire region of the contact portion of the sprocket 400 with the inner circumferential surface 421 of the shaft bore of the boss portion 420 other than the keyway 430. Thus, the key K is not dislodged inadvertently and seizing in the contact portion between the sprocket and the inner circumferential surface 421 of the shaft bore of the boss portion 420 can be completely avoided, and containment of the solid lubricant 440 can be more ensured.

The solid lubricant 440 used in the fourth example is solidified in polyethylene with lubricant dispersedly held, and polyethylene of the solid lubricant 440 is gradually softened by heat generated by kinetic energy, which occurs in the sprocket 400 during power transmission. Lubricating oil dispersed and held in polyethylene is gradually diffused. Therefore, lubricating oil enough to form an oil film in the clearance gap between the inner circumferential surface 421 of the sprocket shaft bore and the sprocket shaft S can be continuously supplied for a long period of time. When the temperature of a contact portion with the sprocket shaft S is excessively increased, the molecular movement of polyethylene is activated so that a mutual separating action is accelerated. Thus an amount of dispersed lubricating oil is increased so that seizing is prevented.

Therefore, the beneficial effects of the first example are very large.

1. A shaft antiseizing type sprocket comprising a boss portion with a shaft bore and means to fix the sprocket to a shaft, and a sprocket teeth portion integrally molded with said boss portion, said sprocket including
a solid lubricant embedded in said boss portion and disposed in a partially exposed state toward the inner circumferential surface, said shaft bore of said boss portion.

2. A shaft antiseizing type sprocket according to claim 1, characterized in that said solid lubricant is solidified in polyethylene with said lubricant dispersedly held therein.

3. A shaft antiseizing type sprocket according to claim 1, characterized in that said solid lubricant is of a composition that is gradually softened by heat and forms a lubricating film between said bore and the shaft on which the sprocket is fixed.

4. A shaft antiseizing type sprocket according to claim 3, characterized in that said solid lubricant is of a composition that becomes fluid by the generation of heat and forms a film between said bore and the shaft by capillary attraction.

5. A shaft antiseizing type sprocket according to claim 1, wherein said means to fix the sprocket to the shaft comprises an axially-extending keyway in the inner circumferential surface of said bore, said keyway constructed and arrange to cooperate with a key projecting radially from the shaft to fix said sprocket on the shaft, said boss portion having at least one groove intersecting said keyway, said lubricant being embedded in said at least groove, said at least one annular circumferential groove intersecting the keyway

6. A shaft antiseizing type sprocket according to claim 5, wherein said at least one circumferential groove being located in the center of said bore, said lubricant being in the form of an annular ring embedded in said circumferential groove.

7. A shaft antiseizing type sprocket according to claim 5, wherein said at least one circumferential groove comprises a pair of annular grooves at the opposite ends of said bore, and said solid lubricant is in the form of a pair of annular rings embedded in said grooves.

8. A shaft antiseizing type sprocket according to claim 1, wherein said means to fix the sprocket to the shaft comprises an axially-extending keyway in the inner circumferential surface of said bore, said keyway constructed and arrange to cooperate with a key projecting radially from the shaft to fix said sprocket on the shaft, said boss portion having at least one groove parallel to said keyway, said lubricant being in the form of at least one axial bar embedded in said at least one groove.

9. A shaft antiseizing type sprocket according to claim 1, wherein said means to fix the sprocket to the shaft comprises a keyway in the circumferential surface of said bore, said keyway constructed and arrange to cooperate with a key projecting radially from the shaft to fix said sprocket on the shaft, said the inner circumferential surface of said bore of said boss portion having at least one circumferential groove intersecting said keyway, said boss portion having at least one radial bore extending from said inner circumferential surface to an exterior surface of said boss, said lubricant being in the form of at least one radially extending plug embedded in said at least radial bore.
